(19) United States
(12) Patent Application Publication
(10) Pub. No.: US 2026/0006199 A1
(43) Pub. Date: Jan. 1, 2026

(54) Learned Transforms For Coding

(71) Applicant: Lyndon Duong

(72) Inventor: Lyndon Duong

(21) Appl. No.: 19/121,005

(22) PCT Filed: Dec. 15, 2022
(86) PCT No.: PCT/US2022/053021

§ 371 Date: Apr. 14, 2025

(51) Int. Cl. H04N 19/12; H04N 19/147; H04N 19/176; H04N 19/196

(52) U.S. Cl. CPC H04N 19/12; H04N 19/147; H04N 19/176; H04N 19/198

(57) ABSTRACT

Decoding a current block includes receiving a compressed bitstream. A transform block of transform coefficients is decoded from the compressed bitstream. The transform coefficients are in a transform domain. The transform block is input to a machine-learning model to obtain a residual block that is in a pixel domain. The residual block is used to reconstruct the current block. Encoding a current block includes receiving a current residual block. The current residual block and a specified rate-distortion parameter are input to a machine-learning model to obtain a quantized transform block. The quantized transform block is entropy encoded into a compressed bitstream.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including compression and other coding techniques. These techniques may include both lossy and lossless coding techniques.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a method for decoding a current block. The method also includes receiving a compressed bitstream. The method also includes decoding a transform block of transform coefficients from the compressed bitstream, where the transform coefficients are in a transform domain. The method also includes inputting the transform block to a machine-learning model to obtain a residual block that is in a pixel domain. The method also includes using the residual block to reconstruct the current block. Other embodiments of this aspect include corresponding computer systems, apparatus, and computer programs recorded on one or more computer storage devices, each configured to perform the actions of the methods. Implementations may include one or more of the following features.

The method may include decoding a latent space representation of the transform block from the compressed bitstream; and obtaining based on the latent space representation a probability distribution for decoding the transform block.

Obtaining based on the latent space representation the probability distribution for decoding the transform block may include inputting the latent space representation into a context parameter extractor machine-learning model to obtain a parameter; and obtain the probability distribution based on the parameter. The parameter can be at least one of a mean or a standard deviation of a gaussian distribution of the probability distribution. The parameter can be an index of the probability distribution into a look-up-table. In some implementations, the parameter constitutes the probability distribution.

The machine-learning model can be trained to perform an inverse linear transform. The machine-learning model can be trained to perform an inverse non-linear transform.

An indication of a bitrate can be further input to the machine-learning model. Decoding the transform block of coefficients from the compressed bitstream may include decoding at least two of the transform coefficients in parallel.

One general aspect includes a method for encoding a current block. The method also includes receiving a current residual block. The method also includes inputting the current residual block and a specified rate-distortion parameter to a machine-learning model to obtain a quantized transform block. The method also includes entropy encoding the quantized transform block into a compressed bitstream. Other embodiments of this aspect include corresponding computer systems, apparatus, and computer programs recorded on one or more computer storage devices, each configured to perform the actions of the methods. Implementations may include one or more of the following features.

The method where the quantized transform block is entropy encoded into the compressed bitstream using a probability distribution that is obtained based on a latent space representation of the quantized transform block.

The method may include inputting the quantized transform block into a machine-learning model that encodes the latent space representation of the quantized transform block. The machine-learning model that encodes the latent space representation of the quantized transform block can be a hyperprior transform.

One general aspect includes a method for decoding a current block. The method also includes receiving a compressed bitstream. The method also includes decoding a latent space representation of a quantized transform block. The method also includes obtaining based on the latent space representation a probability distribution for decoding quantized transform block. The method also includes decoding, using the probability distribution, the quantized transform block from the compressed bitstream. The method also includes inputting the transform block to a machine-learning model to obtain a residual block that is in a pixel domain. The method also includes reconstructing the current block based on the residual block. Other embodiments of this aspect include corresponding computer systems, apparatus, and computer programs recorded on one or more computer storage devices, each configured to perform the actions of the methods. Implementations may include one or more of the following features.

Obtaining based on the latent space representation the probability distribution for decoding quantized transform block may include obtaining a parameter indicative of the probability based on the latent space representation. The parameter can be at least one of a mean or a standard deviation of a gaussian distribution of the probability distribution. The parameter can be an index of the probability distribution into a look-up-table. Implementations of the described techniques may include hardware, a method or process, or computer software on a computer-accessible medium.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. For example a non-transitory computer-readable storage medium may include executable instructions that, when executed by a processor, facilitate performance of operations operable to cause a processor to carry out methods described herein. Aspects can be combined such that features described in the context of one aspect may be implemented in another aspect.

These and other aspects of the present disclosure are disclosed in the following detailed description of the embodiments, the appended claims, and the accompanying figures.

### BRIEF DESCRIPTION OF THE DRAWINGS

The description herein refers to the accompanying drawings described below wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of an example of a video stream to be encoded and subsequently decoded.

FIG. 4 is a block diagram of an encoder.

FIG. 5 is a block diagram of a decoder.

FIG. 6 illustrates a framework for transform and/or entropy coding using machine-learning (ML).

FIG. 7 is an example of a flowchart of a technique for decoding a current block.

FIG. 8 is an example of a flowchart of a technique for encoding a current block.

FIG. 9 is an example of an encoder that uses an ML model to transform a residual block.

FIG. 10A is an example of a decoder that uses an inverse transform ML model to obtain a residual block.

FIG. 10B is an example of a decoder that uses an inverse transform ML model to obtain a residual block.

### DETAILED DESCRIPTION

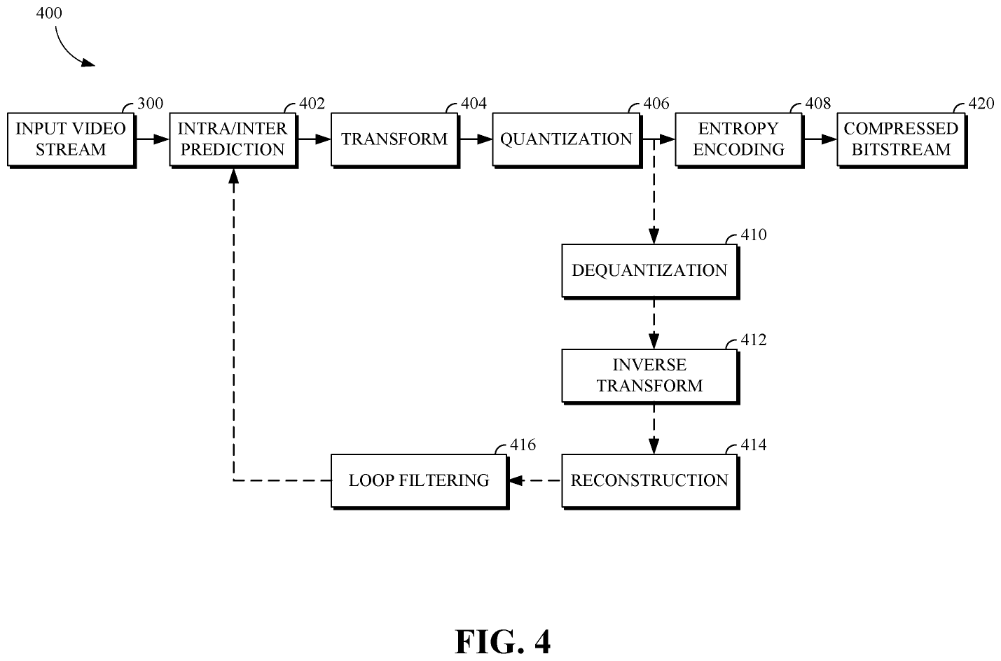

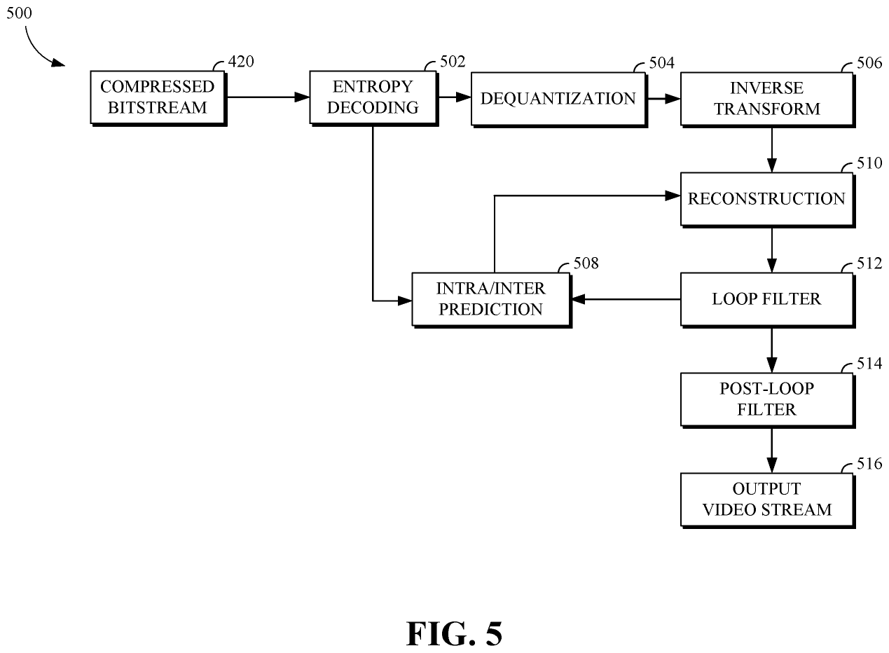

Encoding an image may traditionally include a prediction stage, a transform stage, a quantization stage, and an entropy encoding stage, as further described with respect to FIG. 4. Decoding an image may traditionally include an entropy decoding stage, a dequantization stage, an inverse transform stage, and a prediction stage, as described with respect to FIG. 5.

The transform stage of an encoder may transform a residual block (e.g., a pixel-wise difference between a source image block and a prediction block of the source block) from the pixel domain to the transform domain by applying one-or two-dimensional linear transforms, such as a discrete cosine transform (DCT) or an asymmetric discrete sine transform (ADST), or another transform. The transform stage produces a transform block that includes transform coefficients. The transform coefficients may be quantized and entropy encoded in a compressed bitstream. The decoder reverses these stages, as described below.

The transforms used by a codec are typically predesigned linear transforms and are typically designed to be simple and fast. However, linear transforms may be incapable of handling higher-order dependencies and non-linearities known to exist in residual blocks and are, thus, sub-optimal for real-world images and videos.

Implementations according to this disclosure use an ML model (referred to herein as a transform ML model) that is trained to transform a residual block to the transform domain and an ML model (referred to herein as an inverse transform ML model) that is trained to invert a transform domain block to the pixel domain. The transform ML model and the inverse transform ML model may each be a neural network, which may be a convolutional neural network (CNN). The transform ML model and the inverse transform ML model are referred to together as a “pair of transform models.”

The ML models may be trained to learn linear or non-linear transforms. As such, transforming using the ML model provides a data-driven approach to learn linear or nonlinear models that better capture higher-order statistics found in natural image/video prediction residuals. A characteristic of the transform and inverse transform ML models is, what is referred to herein as, rate-distortion (R-D) universality. That is, a single adaptive model can operate at multiple points along the R-D curve, therewith resulting in a simplified parameter space complexity, while maintaining high R-D performance.

In other aspects, machine learning may be trained for the selection of a probability distribution that can be used by an entropy coder for entropy coding. A latent space extractor may be trained to encode the latent space (e.g., salient features) of a transform block. The latent space can be descriptive of, indicative of, or otherwise useful in selecting or coding a context for selecting a probability distribution for coding the coefficients of the transform block. Another ML model (referred to herein as context parameter extractor) receives as inputs the encoded latent space and outputs one or more parameters that can be or can be used to select a probability distribution used for entropy coding. The latent space extractor and the context parameter extractor are referred to together as a “pair of context selector models.”

Using one or both of the pair of transform models and the pair of context selector models can improve compression efficiency over traditional techniques for transform and context selection. One or both of the pair of transform models and the pair of context selector models can be used to replace existing transform, quantization, or entropy coding stages in an image or video codecs.

Further details of motion vector coding using a motion vector precision are described herein with initial reference to a system in which it can be implemented.

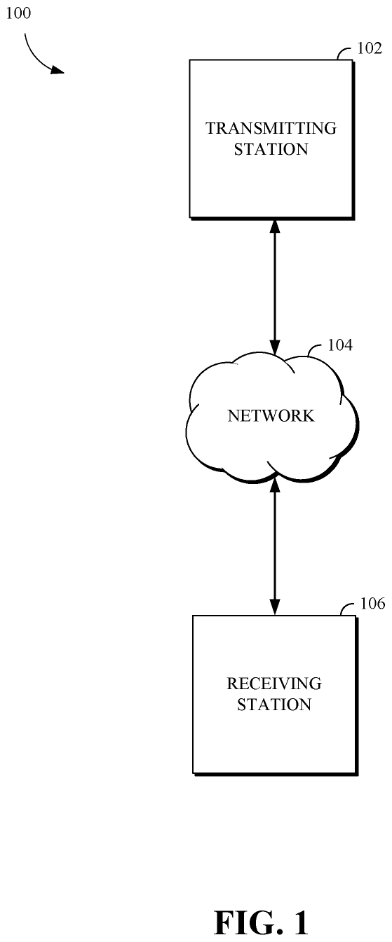

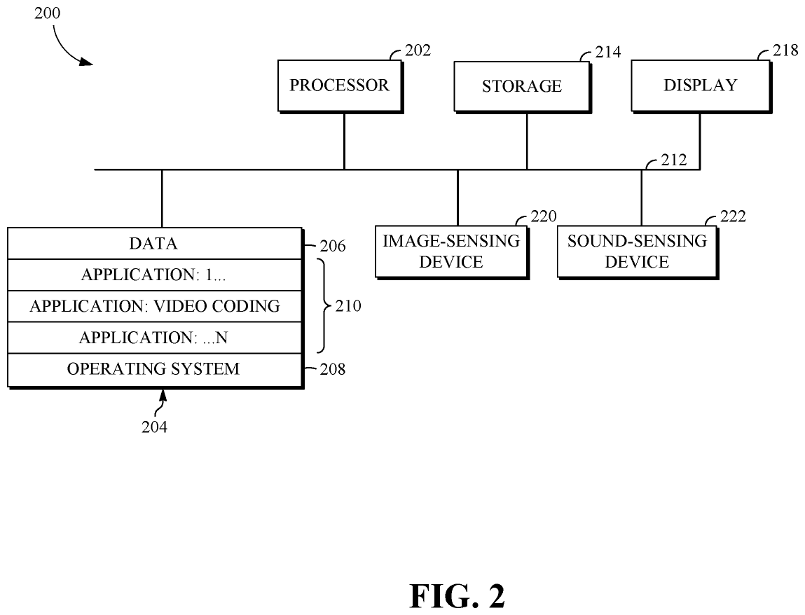

FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102 and the encoded video stream can be decoded in the receiving station 106. The network 104 can be, for example, the Internet. The network 104 can also be a local area network (LAN), wide area network (WAN), virtual private network (VPN), cellular telephone network or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a Hypertext Transfer Protocol (HTTP) video streaming protocol.

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits its own video bitstream to the video conference server for decoding and viewing by other participants.

FIG. 2 is a block diagram of an example of a computing device 200 (e.g., an apparatus) that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A CPU 202 in the computing device 200 can be a conventional central processing unit. Alternatively, the CPU 202 can be any other type of device, or multiple devices, capable of manipulating or processing information now existing or hereafter developed. Although the disclosed implementations can be practiced with one processor as shown, e.g., the CPU 202, advantages in speed and efficiency can be achieved using more than one processor.

A memory 204 in computing device 200 can be a read only memory (ROM) device or a random-access memory (RAM) device in an implementation. Any other suitable type of storage device can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the methods described here. For example, the application programs 210 can include applications 1 through N, which further include a video coding application that performs the methods described here. Computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display or light emitting diode (LED) display, such as an organic LED (OLED) display.

The computing device 200 can also include or be in communication with an image-sensing device 220, for example a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into one unit, other configurations can be utilized. The operations of the CPU 202 can be distributed across multiple machines (wherein individual machines can have one or more of processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

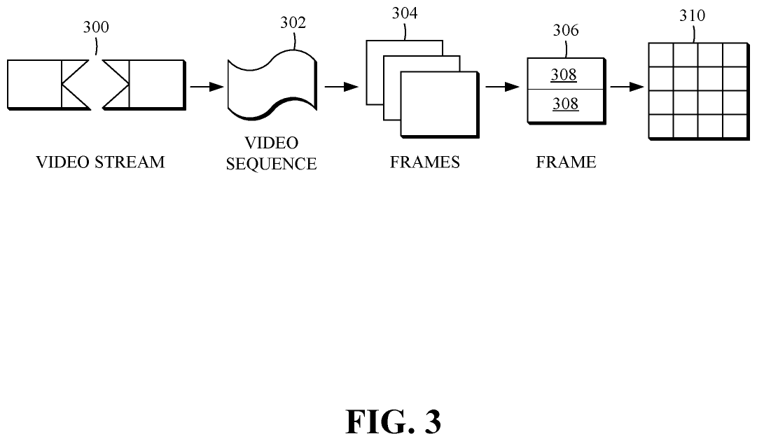

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, e.g., a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macro-block are used interchangeably herein.

FIG. 4 is a block diagram of an encoder 400. The encoder 400 is a traditional encoder that can be implemented, as described above, in the transmitting station 102 such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

When the video stream 300 is presented for encoding, respective frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block, which may include for example the type of prediction used, transform type, motion vectors and quantizer value, are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs functions that are similar to functions that take place during the decoding process that are discussed in more detail below, including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform-based encoder can quantize the residual signal directly without the transform stage 404 for certain blocks or frames. In another implementation, an encoder can have the quantization stage 406 and the dequantization stage 410 combined in a common stage.

FIG. 5 is a block diagram of a decoder 500. The decoder 500 is a traditional decoder that can be implemented in the receiving station 106, for example, by providing a computer software program stored in the memory 204. The computer software program can include machine instructions that, when executed by a processor such as the CPU 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512 and a post-loop filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts.

Other filtering can be applied to the reconstructed block. In this example, the post-loop filtering stage 514 is applied to the reconstructed block to reduce blocking distortion, and the result is output as the output video stream 516. The output video stream 516 can also be referred to as a decoded video stream, and the terms will be used interchangeably herein. Other variations of the decoder 500 can be used to decode the compressed bitstream 420. For example, the decoder 500 can produce the output video stream 516 without the post-loop filtering stage 514.

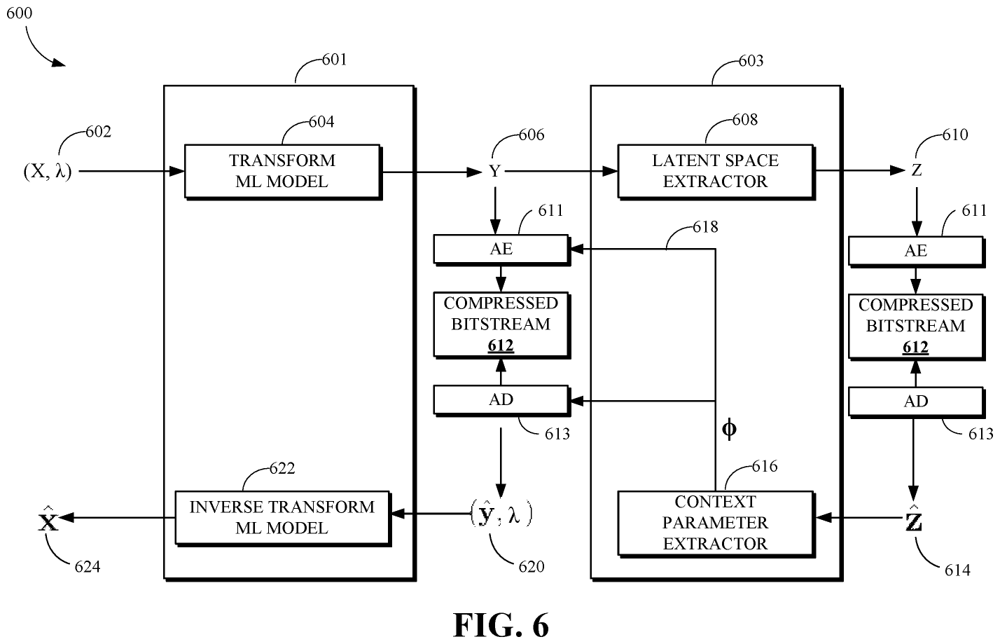

FIG. 6 illustrates a framework 600 for transform and/or entropy coding (i.e., encoding and decoding) using machine learning. The framework 600 is shown as including a pair of transform models 601, which can be CNNs, that serve as the forward (using a transform ML model 604) and an inverse (using an inverse transform ML model 622) joint transform operations, and a pair of context selector models 603 that operate on the transform coefficients and adapt the entropy model to a current context (e.g., the transform coefficients), thereby acting as a hyperprior over the transform coefficients. As is known, “hyperprior” is a term used in Bayesian probability theory that, in this context, may indicate a prior probability distribution over the transform coefficient probability distribution. “Hyper” may imply or mean hierarchically layered/nested. The pair of context selector models 603 is shown as including latent space extractor 608 and a context parameter extractor 616, which can be used jointly to select (e.g., identify) a probability distribution that is used for entropy coding the transform coefficients 606.

The models of the pair of transform models 601 (i.e., the transform ML model 604 and the inverse transform ML model 622) each includes a base set of (trained) parameters that are fixed across different R-D trade-offs, as well as a smaller set of modulation parameters that configure each of the transform ML model 604 and the inverse transform ML model 622 to adapt to different bit rate requirements rapidly and reversibly. The adaptive nature of the CNN transform in conjunction with the neural network entropy model enable the framework 600 to adapt to different points along the R-D curve.

The framework 600 may be referred to as Nonlinear Residual Compressive Autoencoder (NRCA). In the context of machine learning, an autoencoder receives an input, can include one or more bottleneck layers, and eventually reconstructs the input. The bottleneck layer(s) serve to identify the latent space (i.e., the salient or important features) of the input.

Operations of an encoder are now described. At an encoder, inputs 602 are input to the transform ML model 604. The inputs 602 include a residual block (denoted X) and a lambda parameter (λ). The residual block X can be obtained from a prediction stage of an encoder, such as the intra/inter prediction stage 402 of FIG. 4. The inputs 602 may include other inputs. Lambda (λ) specifies a bit rate for the encoding. Lambda may also be referred to or may be known as a Lagrange multiplier. The transform ML model 604 outputs a transform coefficients 606 (denoted Y, where Y is the transform block).

In another example, instead of or in addition to Lambda, a value that is obtained using a non-linear function of a quantization parameter can be input to the transform ML model 604. As is known, quantization parameters in video codecs can be used to control the tradeoff between rate and distortion. Usually, a larger quantization parameter means higher quantization (such as of transform coefficients) resulting in a lower rate but higher distortion; and a smaller quantization parameter means lower quantization resulting in a higher rate but a lower distortion. The variables QP, q, and Q may be used interchangeably to refer to a quantization parameter.

The QP can be used to derive a multiplier (i.e., λ) that is used to combine the rate and distortion values into one metric (e.g., an encoding cost). If R denotes the rate, and D denotes the distortion, then the cost of encoding can be given by: cost=R+λD. Some codecs may refer to the multiplier as the Lagrange multiplier (denoted λ_{mode}); other codecs may use a similar multiplier that is referred as rdmult. Each codec may have a different method of calculating the multiplier due in part to the fact that the different codecs may have different meanings (e.g., definitions, semantics, etc.) for, and methods of use of, quantization parameters.

Codecs (referred to herein as H.264 codecs) that implement the H.264 standard may derive the Lagrange multiplier λ_{mode} using formula (1):

$${λ}_{mode} = 0.85 \times {2}^{( Q P - 12 ) / 3} \qquad ( 1 )$$

Codecs (referred to herein as HEVC codecs) that implement the High Efficiency Video Codec (HEVC) standard may use a formula that is similar to the formula (1). Codecs (referred to herein as H.263 codecs) that implement the H.263 standard may derive the Lagrange multipliers λ_{mode} using formula (2):

$${λ}_{m o d e} = 0.85 \cdot {Q}_{H 263}^{2} \qquad ( 2 )$$

Codecs (referred to herein as VP9 codecs) that implement the VP9 standard may derive the multiplier rdmult using formula (3):

$$rdmult = 88 \cdot {Q}^{2} / 24 \qquad ( 3 )$$

Codecs (referred to herein as AV1 codecs) that implement the AVI standard may derive the Lagrange multiplier λ_{mode} using formula (4):

$${λ}_{m o d e} = 0.12 \cdot {Q}_{AV 1}^{2} / 256 \qquad ( 4 )$$

As can be seen in the above cases, the multiplier has a non-linear relationship to the quantization parameter. In the cases of HEVC and H.264, the multiplier has an exponential relationship to the quantization parameter (QP); and in the cases of H.263, VP9, and AV1, the multiplier has a quadratic relationship to the QP.

The transform ML model 604 can be thought of as performing an analysis on the residual block to optimally (i.e., according to the training of the transform ML model 604) transform the residual block X to the transform domain to obtain the quantized transform block Y. While not specifically shown in FIG. 6, and as mentioned above, the transform ML model 604 can use a first fixed set of parameters and a second variable set of parameters. The first fixed set of parameters can be thought of as being applicable to all points along the rate-distortion (RD) curve. The second set of parameters can be trained to adapt the first set of parameters to particular points along the RD curve. To illustrate, the first set of parameters may be 100,000 parameters (e.g., weights) and the second set of parameters may include 10,000 parameters that specialize (e.g., adapt) the first set of parameters for a first value of lambda, another 10,000 parameters for a second value of lambda, and so on. The transform ML model 604 can be explicitly configured to distinguish between common parameters and parameters that depend on lambda. The transform ML model 604 can include layers that in turn include lambda-dependent nonlinear activation functions, f(v, λ), where v can be the output of a layer (whose parameters are part of the common set of parameters). f( ) can be a function with trainable parameters; and v will depend on the common parameters. The functions f(v, λ) (since they depend on λ) enable the transform ML model 604 to adapt to λ. The inverse transform ML model 622 can be similarly configured and trained.

Said another way, most of the components (e.g., layers, weights, groups of layers, etc.) in the transform ML model 604 (and, similarly, the inverse transform ML model 622) can be shared along the RD curve. That is, these shared components are independent of the input λ. Assuming that it is desirable to train the ML model for only two points along the RD curve (i.e., a low bit rate corresponding to a lambda value of λ₁ and a high bit rate corresponding to a lambda value of λ₂), a component in the ML model can implicitly learn that the residual X is to traverse a first route through the ML model corresponding to λ₁ and to traverse a second route through the ML model corresponding to λ₂. As such, the transform ML model 604 (and, similarly, the inverse transform ML model 622) can be or include one neural network that can be universally shared for at least some (e.g., all) possible bit rates along the RD curve, and include modular components that are adaptive to specific points along that RD curve.

As such, the transform ML model 604 (and, similarly, the inverse transform ML model 622) can be thought of as being a static network that is able to switch finely specialized components in order to operate at different parts of the RD curve. For bit rates (e.g., λ values) that were not directly specified during training, the ML model interpolates between two existing adaptive parameter sets. To illustrate, the ML model may be trained using λ=1, 2, 3, 4, 5, 6, etc. If λ=4.5 is presented as an input during the inference phase (i.e., at runtime), the ML model will be able to interpolate the learned weights of the ML model to derive a special module for λ=4.5. That is, the ML model is able to operate at the 4.5 level since the ML model was trained using values around to input value of 4.5.

The transform coefficients 606 can be input to the latent space extractor 608 that is trained to map the transform coefficients 606 to a transform coefficient latent space 610 (denoted Z) via machine-learned hyper-analysis transform that may not be explicitly dependent on λ. The latent space extractor 608 is a hyperprior network that operates on the transform coefficients 606 to perform a further stage of transform of the transform coefficients 606 into a deeper space Z (i.e., the transform coefficient latent space 610). The transform coefficient latent space 610 includes, or can be used to obtain, a parameter φ that can be used to inform and adapt the entropy model in the original space (i.e., the original coefficient space).

The transform coefficient latent space 610 can be quantized and losslessly encoded by an arithmetic encoder 611 into a compressed bitstream 612 that is transmitted to a decoder. At the decoder, the quantized value may be decoded by an arithmetic decoder 613 to obtain a decoded latent space 614 (denoted \hat{Z}). In an example, the transform coefficient latent space 610 may be entropy coded using a machine-learned probability model. The transform coefficients Y are more numerous than the Z coefficients, by design. The number of bits required to encode Z is typically very small. The hyper-synthesis transform (i.e., the context parameter extractor 616) is able to expand (e.g., explode or grow) that small amount of information into a large representation to improve the coding of the transform coefficients 606.

The decoded latent space 614 (\hat{Z}) is input to an ML hyper-synthesis transform (i.e., the context parameter extractor 616) to yield the parameter ϕ. The parameter ϕ can be used to select a probability model (i.e., distribution) of entropy coding the transform coefficients 606 of the transform block Y. In an example, the parameter ϕ can be or include a mean and a standard deviation of a Gaussian distribution. In an example, the parameter ϕ may be an index of a probability model where the index can be used to select a probability from a look-up-table of probability models. In an example, the parameter o may be the probability distribution itself.

The transform coefficient latent space 610 (Z) carries information about all of the transform coefficients 606. As such, the hyper-synthesis (i.e., the context parameter extractor 616) outputs a parameter ϕ that can be used to more accurately (as compared to backward adaptation of probability distributions) select a probability model for a given set of transform coefficients Y. That is, the transform coefficient latent space 610 (Z) can be used to inform the decoder of the context for the entropy model.

By including, in the compressed bitstream 612, bits resulting from the encoding of the transform coefficient latent space 610 (Z), the overall size of the compressed bitstream 612 may be reduced because the parameter ϕ results is selecting a probability model that better reflects (e.g., better models) the statistics of the transform coefficients 606 because the transform coefficient latent space 610 (Z) includes information regarding all the coefficients of Y resulting in a more precise context for entropy model than other techniques (e.g., backward adaptation techniques) that consider only a few previously decoded, neighboring transform coefficients.

With backward adaptation techniques, the transform coefficients may be decoded sequentially (according to a scan order). To decode a current transform coefficient, the previously decoded, neighboring transform coefficients must first be available so that a probability model can be selected for the current coefficient. Contrastingly, the transform coefficient latent space 610 (Z) enables an encoder to encode (and a decoder to decode) and reconstruct the coefficients in parallel because the same probability distribution can be used to encode (and decode) all of the transform coefficients.

The parameter ϕ is input (e.g., provided, presented, etc.) to the arithmetic encoder 611 by the signal 618 to adapt the encoder's probability model for Y and code the transform coefficients 606 into the compressed bitstream 612. The transform coefficients Y may be quantized and encoded and decoded to Ŷ (decoded transform coefficients 620) using the adapted probability model based on the parameter ϕ.

In an example, the transform ML model 604 may be trained to output transform coefficients, which are then separately quantized (by a quantization phase not shown in FIG. 6) before being encoded into a compressed bitstream 612; and the inverse transform ML model 622 may be trained to receive dequantized transform coefficients. In this case, quantized transform coefficients may be extracted from the compressed bitstream 612, dequantized (by a dequantization phase not shown in FIG. 6) to generate the dequantized transform coefficients, which are then input to the inverse transform ML model 622 to obtain a residual block (denoted below as \hat{X}). In another example, the transform ML model 604 may be trained to output quantized transform coefficients; and the inverse transform ML model 622 may be trained to receive quantized transform coefficients to output a residual block.

As such, in some examples, the transform coefficients Y may already be quantized coefficients and, as such, they need not be quantized again before being encoded in the compressed bitstream 612. It is noted that, if the transform coefficients 606 are quantized coefficients, then the decoded transform coefficients 620 (Ŷ) are equal to the transform coefficients 606 (Y); otherwise Ŷ are equal to the quantized values of the transform coefficients 606. For brevity, and simplicity of explanation, the transform coefficients 606 may refer to either quantized transform coefficients or transform coefficients before quantization; and the decoded transform coefficients 620 may refer to either dequantized transform coefficients or quantized transform coefficients.

The decoded transform coefficients 620 (Ŷ) and λ are then input into the inverse transform ML model 622 (which is a synthesis transform model with adaptive A-dependent parameters) to obtain a reconstructed residual block 624 (denoted \hat{X}). The reconstructed residual block 624 can be added to a prediction block (not shown) to obtain a decoded current block.

At a decoder, which may be a reconstruction path of the encoder, \hat{Z} can be decoded from the compressed bitstream 612 and input to an ML hyper-synthesis transform (i.e., the context parameter extractor 616) to yield the parameter ϕ. The parameter ϕ is input to the arithmetic decoder 613, which then obtains a probability distribution as described above. The encoder and decoder are configured to use the same probability distributions in order to compress/decompress the transform coefficients. The decoder obtains (e.g., calculates) lambda using the quantization parameter QP, which is received in the compressed bitstream 612.

In an example, coding according to implementations of this disclosure may not use the pair of context selector models 603 for obtaining a probability distribution model. As such, other techniques can be used for context selection (such as using previously decoded, neighboring transform coefficients). In another example, a pre-configured probability distribution may be used.

In an example, coding according to implementations of this disclosure may not use the pair of transform models 601. That is, coding according to implementations of this disclosure can only use the pair of context selector models 603 for obtaining a probability distribution model and rely on traditional transform techniques (such applying DCT or other transforms) to obtain the transform block.

In an example, the pair of transform models 601 are each trained to perform linear transforms. Each of the ML models of the pair of transform models 601 may be trained to learn and perform linear transforms by removing non-linearities in the ML models. Removing non-linearities can include not using activation functions to activate the nodes of the ML models. By removing the activation functions, the ML model reduce to performing matrix multiplications of the weights of the nodes with inputs to the nodes. Matrix multiplication is essentially a linear transform.

In an example, the transform ML model 604 and the inverse transform ML model 622 may be symmetric. That is, for example, each of the ML models 604 and 622 may have similar structures and relatively the same number of parameters (e.g., layers, nodes, etc.).

In some situations, sufficient time and resources may be available to an encoder to encode a video stream; however, a decoder may be time-and/or resource-constrained. As such, the decoder (e.g., a device executing the decoder) may not be able to support an inverse transform ML model that is as large as the transform ML model used by the encoder. In such cases, the ML models of the pair of transform models 601 need not be symmetric. The inverse transform ML model can apply or include fewer layers and/or nodes than the transform ML model. In an example, a parameter reduction process may be executed on a trained inverse transform ML model to reduce its size. In another example, the inverse transform ML model may be configured with a smaller number of parameter before training begins.

Training of the ML models may be performed as follows. Residual blocks obtained from a video codec by encoding natural image/video dataset are used as training data. As already alluded to, a single, universal model that is capable of operating at all points along the R-D curve is trained using an R-D optimization approach. This can be accomplished by adjusting a Lagrangian R-D loss to random, uniformly sampled points along the R-D curve during training. The transforms, quantizers, and entropy models can be jointly trained using standard error back-propagation and first-order stochastic gradient descent methods to minimize this R-D Lagrangian loss function.

Whereas the base set of parameters in the transform CNNs (i.e., the ML models of the pair of transform models 601) and the entropy model CNNs (i.e., the ML models of the pair of context selector models 603) are trained for all R-D trade-offs, a small set of adaptive parameters is trained for each specific R-D loss, as already mentioned. For rates that were not directly specified during training, the ML models are capable of interpolating between two existing adaptive parameter sets. The loss function used for training can be the entropy of the main bit stream (i.e., the bitstream that includes the encoded transform coefficients) and the side bit stream (i.e., the bitstream that includes the latent space representation of the transform block) as well as the reconstruction loss (i.e., distortion). Said another way, the loss function used can be RD cost for encoding the residual block X. As indicated above, the loss function, which the training process attempts to minimize, can be given by R+λD. Accordingly, the single obtained model can operate across all points on the R-D curve. Notably, this requires the model to be trained once, rather than training a base model and subsequently transfer-learning its parameters using a different loss or dataset.

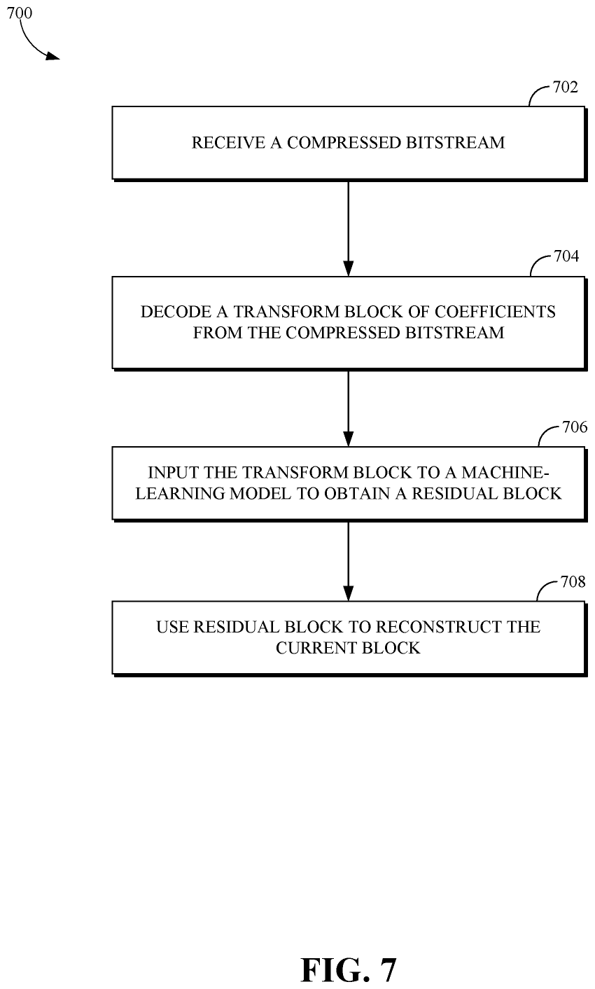

FIG. 7 is an example of a flowchart of a technique 700 for decoding a current block. The technique 700 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 700. The technique 700 can be implemented using specialized hardware or firmware. Multiple processors, memories, or both, may be used.

At 702, a compressed bitstream is received. The compressed bitstream can be the compressed bitstream 612 of FIG. 6. At 704, a transform block of coefficients is decoded from the compressed bitstream. The transform coefficients are in a transform domain. The transform block of coefficients can be the decoded transform coefficients 620 of FIG. 6. In an example, the transform coefficients can be quantized transform coefficients. As such, the technique 700 can include dequantizing the transform coefficients. In an example, the transform coefficients can be dequantized transform coefficients. In an example, and as described with respect to FIG. 6, at least two of the transform coefficients can be decoded in parallel.

At 706, the transform block is input to an ML model to obtain a residual block. The residual block is in a pixel domain. The ML model can be the inverse transform ML model 622 of FIG. 6. In an example, the ML model is trained to perform an inverse linear transform. In an example, the ML model is trained to perform an inverse non-linear transform. The residual block can be the reconstructed residual block 624 of FIG. 6. In an example, an indication of a bitrate is further input to the ML model, such as described with respect to the lambda parameter (λ). At 708, the residual block is used to reconstruct the current block. For example, a prediction block can be generated using an intra/inter prediction stage, such as the intra/inter prediction stage 508 of FIG. 5. The prediction block can be added to the residual block to obtain the current block.

In an example, the technique 700 can further include decoding a latent space representation of the transform block from the compressed bitstream. The decoded latent space can be decoded latent space 614 of FIG. 6. The latent space representation can be used to obtain a probability distribution for decoding the transform block. As described with respect to FIG. 6, the latent space representation can be used to obtain a parameter φ, which can be used to obtain the probability distribution.

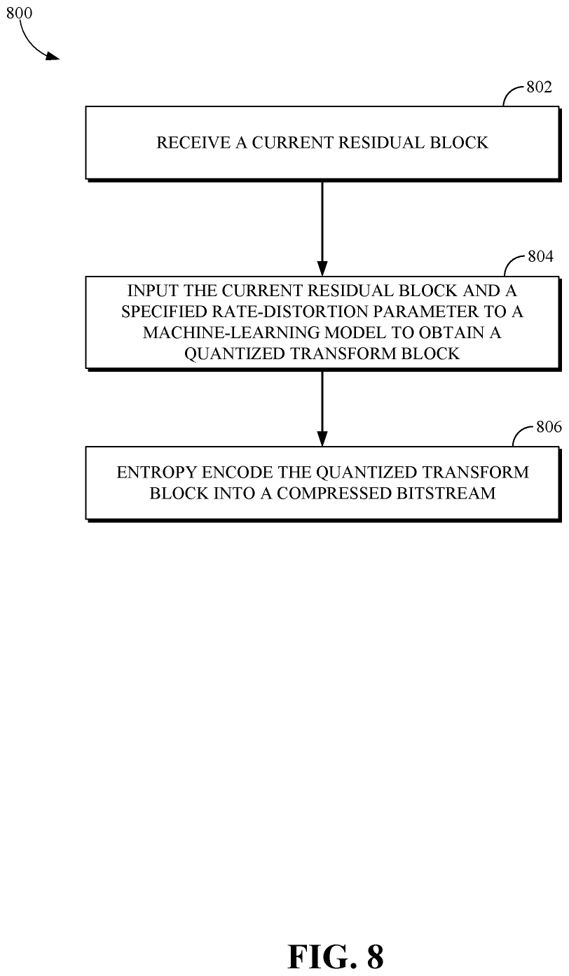

FIG. 8 is an example of a flowchart of a technique 800 for encoding a current block. The technique 800 can be implemented, for example, as a software program that may be executed by computing devices such as transmitting station 102 or receiving station 106. The software program can include machine-readable instructions that may be stored in a memory such as the memory 204 or the secondary storage 214, and that, when executed by a processor, such as CPU 202, may cause the computing device to perform the technique 800. The technique 800 can be implemented using specialized hardware or firmware. Multiple processors, memories, or both, may be used.

At 802, a current residual block is received. The current residual block can be the block X described with respect to FIG. 6. At 804, the current residual block and a specified rate-distortion parameter are input into a ML model to obtain a quantized transform block. The ML model can be the transform ML model 604 of FIG. 6. The quantized transform block can be the transform block Y described with respect to FIG. 6.

At 806, the quantized transform block is entropy encoded into a compressed bitstream, such as the compressed bitstream 612 of FIG. 6. As described above, and in an example, the quantized transform block can be entropy encoded into the compressed bitstream using a probability distribution that is obtained based on a latent state representation of the quantized transform block. As such, the quantized transform block can be input into a ML model (e.g., the latent space extractor 608 of FIG. 6) that encodes the latent space representation of the quantized transform block. The ML model that encodes the latent space information of the quantized transform block can be a hyperprior transform.

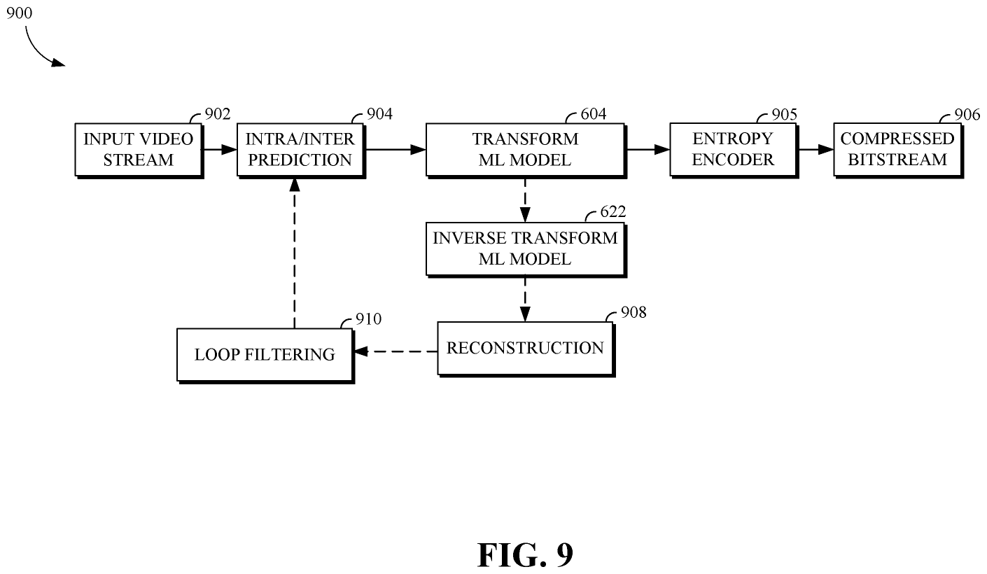

FIG. 9 is an example of an encoder 900 that uses an ML model to transform a residual block. The encoder 900 receives as input a video stream 902, which can be similar to the video stream 300 of FIG. 3. The video stream 902 may be partitioned as described above. The partitioning may include a current block to be encoded. The current block is input to an intra/inter prediction stage 904, which can be or can be similar to the intra/inter prediction stage 402 of FIG. 4. The output of the intra/inter prediction stage 904 is a residual block. The residual block is input to the transform ML model 604 (described with respect to FIG. 6) to generate a quantized transform block, which is entropy encoded into a compressed bitstream 906 using the entropy encoder 905 (which may be or include the arithmetic encoder 611 of FIG. 6).

The quantized transform block can be input into an inverse transform ML model 622 (described with respect to FIG. 6) to obtain the residual block, which is then processed through a reconstruction stage 908 and a loop filtering stage 910, which can be or perform similarly to the reconstruction stage 414 and the loop filtering stage 416 of FIG. 4, respectively.

In an implementation, the encoder 900 may also include the pair of context selector models 603 described with respect to FIG. 6. Specifically, to encode the quantized transform block, the encoder 900 may first obtain a probability distribution based on the latent space representation of the quantized transform block. The latent space representation can be obtained using the latent space extractor 608. The latent state may then be input to the context parameter extractor 616 to obtain the parameter ϕ, as described above, which is used to obtain or may be the probability distribution. In the case that the encoder 900 uses the latent space representation to obtain a probability distribution for encoding the quantized transform block, then the encoder 900 also encodes the latent space representation into the compressed bitstream 906.

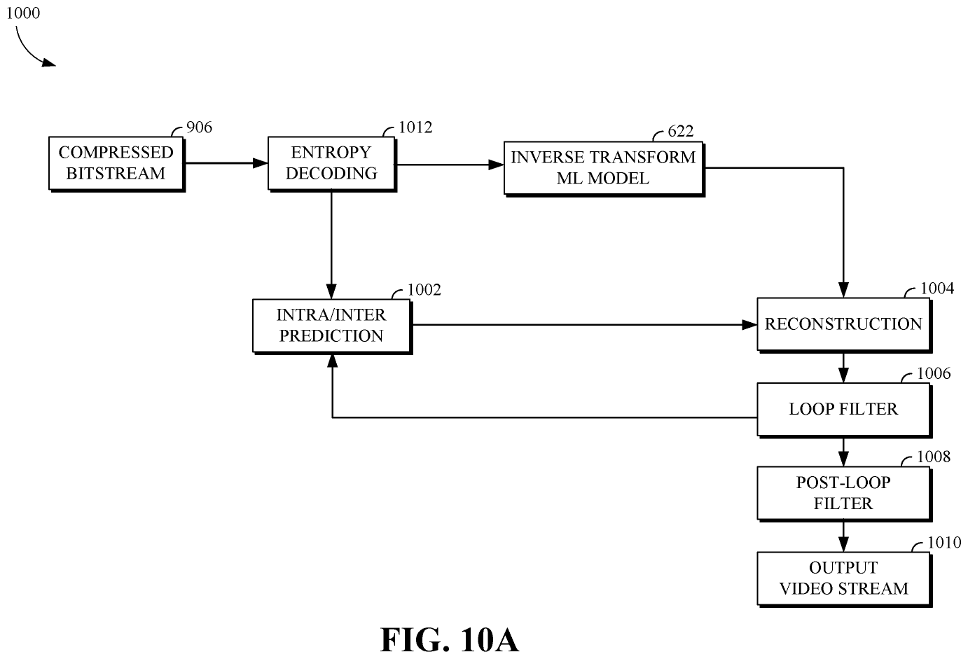

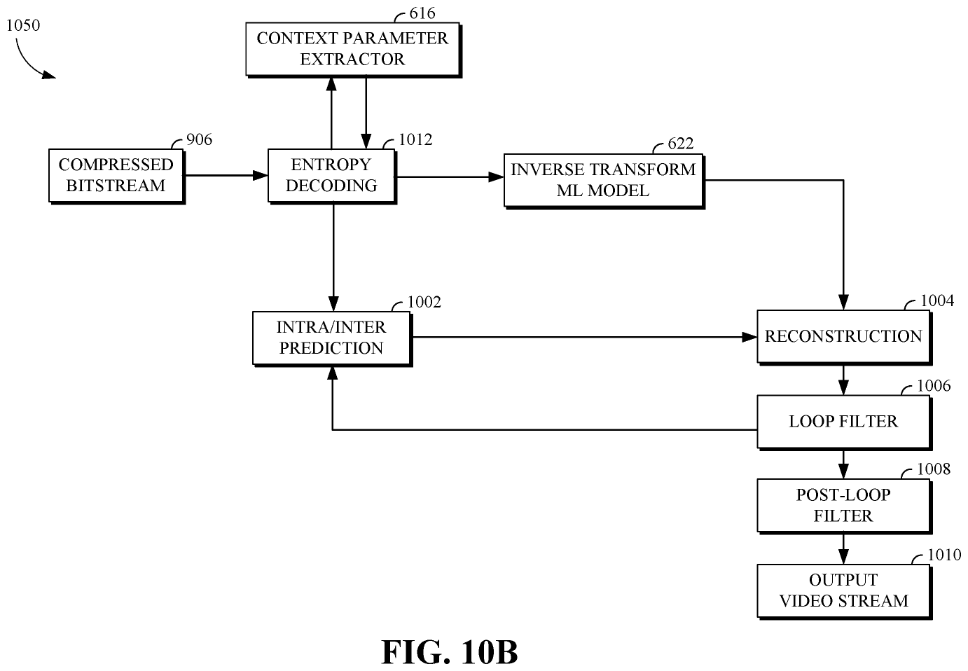

FIG. 10A is an example of a decoder 1000 that uses an inverse transform ML model to obtain a residual block. The decoder 1000 receives the compressed bitstream 906 of FIG. 9. The compressed bitstream may include quantized transform coefficients of a quantized transform block corresponding to a current block to be decoded. The quantized transform coefficients may be entropy decoded using the entropy decoder 1012 (which may be or include the arithmetic decoder 613 of FIG. 6). The quantized transform coefficients are input to the inverse transform ML model 622 (described with respect to FIG. 6). The decoder 1000 includes an intra/inter prediction stage 1002, a reconstruction stage 1004, a loop filtering stage 1006, a post-loop filtering stage 1008, and a output video stream 1010, which can be or can functional similarly to the intra/inter prediction stage 508, the reconstruction stage 510, the loop filtering stage 512, the post-loop filtering stage 514, and the output video stream 516 of FIG. 5, respectively.

FIG. 10B is an example of a decoder 1050 that uses an inverse transform ML model to obtain a residual block. The decoder 1050 differs from the decoder 1000 in that it includes the context parameter extractor 616 (described with respect to FIG. 6). As described with respect to FIG. 6, in some implementations, a probability distribution for decoding the quantized transform block from the compressed bitstream 906 can be based on the latent space representation of the quantized transform block. The latent space representation may be encoded in the compressed bitstream 906 and be decoded by the entropy decoder 1012. The decoded latent space representation can be input to the context parameter extractor 616 to obtain a parameter ϕ for obtaining the probability distribution. The probability distribution can be used by the entropy decoder 1012 to decode the quantized transform block (i.e., the coefficients therefor). The decoded transform block is then input to the inverse transform ML model 622.

Returning briefly to FIG. 6, as mentioned above, each of the transform ML model 604, the inverse transform ML model 622, the latent space extractor 608, and the context parameter extractor 616 can each be a neural network. Each of these ML models can be a deep-learning convolutional ML model (CNN).

In a CNN, a feature extraction portion typically includes a set of convolutional operations, which is typically a series of filters that are used to filter an input (e.g., an image, an image block, a transform block, or any other input) based on a filter (typically a square of size l, without loss of generality). As the number of stacked convolutional operations increases, later convolutional operations can find higher-level features.

A CNN may include a set of fully connected layers, which may be used. The fully connected layers can be thought of as looking at all the input features of an input in order to generate a high-level classifier. Several stages (e.g., a series) of high-level classifiers eventually generate a desired output.

As mentioned, a typical CNN network is composed of a number of convolutional operations (e.g., the feature-extraction portion) followed by a number of fully connected layers. The number of operations of each type and their respective sizes is typically determined during a training phase of the machine learning. As a person skilled in the art recognizes, additional layers and/or operations can be included in each portion. For example, combinations of Pooling, MaxPooling, Dropout, Activation, Normalization, BatchNormalization, and other operations can be grouped with convolution operations (i.e., in the features-extraction portion) and/or the fully connected operation (i.e., in the classification portion). The fully connected layers may be referred to as Dense operations. As a person skilled in the art recognizes, a convolution operation can use a SeparableConvolution2D or Convolution2D operation.

A convolution layer can be a group of operations starting with a Convolution2D or SeparableConvolution2D operation followed by zero or more operations (e.g., Pooling, Dropout, Activation, Normalization, BatchNormalization, other operations, or a combination thereof), until another convolutional layer, a Dense operation, or the output of the CNN is reached. A convolution layer can use (e.g., create, construct, etc.) a convolution filter that is convolved with the layer input to produce an output (e.g., a tensor of outputs). A Dropout layer can be used to prevent overfitting by randomly setting a fraction of the input units to zero at each update during a training phase. A Dense layer can be a group of operations or layers starting with a Dense operation (i.e., a fully connected layer) followed by zero or more operations (e.g., Pooling, Dropout, Activation, Normalization, BatchNormalization, other operations, or a combination thereof) until another convolution layer, another Dense layer, or the output of the network is reached. The boundary between feature extraction based on convolutional networks and a feature classification using Dense operations can be marked by a Flatten operation, which flattens the multidimensional matrix from the feature extraction into a vector.

In a typical CNN, each of the convolution layers may consist of a set of filters. While a filter is applied to a subset of the input data at a time, the filter is applied across the full input, such as by sweeping over the input. The operations performed by this layer are typically linear/matrix multiplications. The activation function may be a linear function or non-linear function (e.g., a sigmoid function, an arcTan function, a tanH function, a ReLu function, or the like).

Each of the fully connected operations is a linear operation in which every input is connected to every output by a weight. As such, a fully connected layer with N number of inputs and M outputs can have a total of N×M weights. As mentioned above, a Dense operation may be generally followed by a non-linear activation function to generate an output of that layer.

For simplicity of explanation, the techniques described herein, such as the techniques 700 of FIGS. 7 and 800 of FIG. 8, are each depicted and described as a respective series of steps or operations. However, the steps or operations in accordance with this disclosure can occur in various orders and/or concurrently. Additionally, other steps or operations not presented and described herein may be used. Furthermore, not all illustrated steps or operations may be required to implement a method in accordance with the disclosed subject matter.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general-purpose computer or general-purpose processor with a computer program that, when executed, carries out any of the respective methods, algorithms and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server and the receiving station 106 can be implemented on a device separate from the server, such as a hand-held communications device. In this instance, the transmitting station 102 can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device and/or a device including an encoder 400 may also include a decoder 500.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor (that is, the computer-readable medium can be a non-transitory computer-readable storage medium). The medium can be, for example, an electronic, magnetic, optical, electromagnetic, or a semiconductor device. Other suitable mediums are also available.

The above-described embodiments, implementations and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

1. A method for decoding a current block, comprising:
receiving a compressed bitstream;
decoding a transform block of transform coefficients from the compressed bitstream, wherein the transform coefficients are in a transform domain;
inputting the transform block to a machine-learning model to obtain a residual block, wherein the residual block is in a pixel domain; and
using the residual block to reconstruct the current block.

2. The method of claim 1, further comprising:
decoding a latent space representation of the transform block from the compressed bitstream; and
obtaining, based on the latent space representation, a probability distribution for decoding the transform block.

3. The method of claim 2, wherein obtaining the probability distribution comprises:
inputting the latent space representation into a context parameter extractor machine-learning model to obtain a parameter; and
obtaining the probability distribution based on the parameter.

4. The method of claim 3, wherein the parameter is one of:
at least one of a mean or a standard deviation of a Gaussian distribution of the probability distribution;
an index of the probability distribution into a look-up-table; or the probability distribution.

5. (canceled)

6. (canceled)

7. The method of claim 1, wherein the machine-learning model is trained to perform one of an inverse linear transform or an inverse non-linear transform.

8. (canceled)

9. The method of claim 1, wherein an indication of a bitrate is further input to the machine-learning model.

10. The method of claim 1, wherein decoding the transform block of coefficients from the compressed bitstream comprises:
decoding at least two of the transform coefficients in parallel.

11. A method for encoding a current block, comprising:
receiving a current residual block;
inputting the current residual block and a specified rate-distortion parameter to a machine-learning model to obtain a quantized transform block; and
entropy encoding the quantized transform block into a compressed bitstream.

12. The method of claim 11, wherein the quantized transform block is entropy encoded into the compressed bitstream using a probability distribution that is obtained based on a latent space representation of the quantized transform block.

13. The method of claim 12, further comprising:
inputting the quantized transform block into a machine-learning model that encodes the latent space representation of the quantized transform block.

14. The method of claim 13, wherein the machine-learning model that encodes the latent space representation of the quantized transform block is a hyperprior transform.

15. The method of claim 1,
wherein decoding the transform block comprises:
decoding a latent space representation of a quantized transform block;
obtaining, based on the latent space representation, a probability distribution for decoding the quantized transform block; and
decoding, using the probability distribution, the quantized transform block from the compressed bitstream to obtain the transform block.

16. The method of claim 15, wherein the probability distribution comprises:
obtaining a parameter indicative of the probability based on the latent space representation.

17. The method of claim 16, wherein the parameter is at least one of a mean or a standard deviation of a Gaussian distribution of the probability distribution.

18. The method of claim 16, wherein the parameter is an index of the probability distribution into a look-up-table.

19. A device, comprising:
a processor; configured to execute the method of claim 1.

20. A device, comprising:
a memory; and
a processor, wherein the memory stores instructions operable to cause the processor to carry out the method of claim 11.

21. A non-transitory computer-readable storage medium storing a compressed bitstream, the compressed bitstream comprising encoded transform coefficients for a transform block of a current block, wherein the encoded transform coefficients are in a transform domain and the compressed bitstream, processed by a processor, causes the processor to decode the current block by a method comprising:
decoding the transform block from the encoded transform coefficients;
inputting the transform block to a machine-learning model to obtain a residual block, wherein the residual block is in a pixel domain; and
using the residual block to reconstruct the current block.

22. The non-transitory computer-readable storage medium of claim 21, wherein the compressed bitstream includes a latent space representation of the transform block, and the method comprises:
decoding the latent space representation; and
obtaining, based on the latent space representation, a probability distribution for decoding the transform block.

23. The non-transitory computer-readable storage medium of claim 22, wherein obtaining the probability distribution comprises:
inputting the latent space representation into a context parameter extractor machine-learning model to obtain a parameter; and
obtaining the probability distribution based on the parameter, wherein the parameter is one of:
at least one of a mean or a standard deviation of a Gaussian distribution of the probability distribution;
an index of the probability distribution into a look-up-table; or
the probability distribution.
